(19) United States
(12) Patent Application Publication
(10) Pub. No.: US 2005/0155284 A1
(43) Pub. Date: Jul. 21, 2005

(54) Plant and flower wind screen including attached stakes

(76) Inventor: Maria Masae Kulas, Savoy, IL (US)

Correspondence Address: CHARLES J. KULAS, 651 ORIZABA AVE., SAN FRANCISCO, CA, 94132, US

(21) Appl. No.: 10/759,775

(22) Filed: Jan. 16, 2004

(51) Int. Cl. A01G 13/02

(52) U.S. Cl. 47/31

(57) ABSTRACT

A wind screen uses flexible sheets of porous material. The sheets include attached stakes at regular intervals. The stakes are stackable so that a wind screen of arbitrary height can be easily constructed. In one embodiment, the sheets can be cut so that the horizontal length of the screen can be easily modified. The flexibility of the sheets and the spacing of the stakes allow a human user to position the windscreen in any arbitrary design or shape, as desired. Assemblies are disclosed whereby two or more stakes can be stacked onto a single stake.

### BACKGROUND OF THE INVENTION

This invention is related in general to agriculture and gardening and more specifically to a flexible screen including stakes for efficiently creating a wind barrier for plants, flowers, shrubs, trees and other vegetation.

It is often desirable to provide wind protection for vegetation such as plants, flowers, shrubs, trees, etc. Sometimes even a moderate wind can damage or completely destroy the vegetation. Plants are susceptible to wind damage depending on the size, strength, plant cross section and other factors. Other reasons to provide such protection can include keeping the plants warmer by protecting against cold air and wind.

### SUMMARY OF THE INVENTION

In one embodiment a wind screen uses flexible sheets of porous material. The sheets include stakes attached at regular intervals. The stake and sheet combination are formed into rolls for easy dispensing, for example, at home or at a point-of-sale. In one embodiment, the sheets can be cut so that the horizontal length of the screen can be easily modified. The flexibility of the sheets and the spacing of the stakes allow a human user to position the wind screen in any of various designs or shapes, as desired.

In another embodiment the stakes are stackable so that wind screens of different heights can be easily constructed. Another embodiment provides for mounting two stakes onto another stake or onto a stake assembly, thus providing more options for windscreen positions and designs.

One embodiment of the invention provides an apparatus for blocking wind, the apparatus comprising a flexible sheet having a length; a plurality of rods, each having a length, coupled at intervals along the length of the flexible sheet, wherein the rods are disposed with the rods substantially parallel to each other, and wherein the rod lengths are substantially normal to the sheet length.

Another embodiment of the invention provides a method for dispensing a wind screen, wherein the wind screen includes a flexible sheet of material having a length and a width, wherein stakes are attached at intervals to the sheet so that the stakes are perpendicular to the length of the flexible sheet, the method comprising forming the wind screen into a roll; unrolling at least a portion of the wind screen; and separating the at least a portion of the unrolled wind screen from the rolled wind screen.

### BRIEF DESCRIPTION OF THE DRAWINGS

FIG. 1 shows a wind screen formed in a rectangular barrier around some plants;

FIG. 2 shows a wind screen formed in a circular barrier.

FIG. 3 shows an enlarged view of a wind screen using a flexible sheet of material with coupled stakes;

FIG. 4 illustrates a stackable stake;

FIG. 5 is a first illustration showing an attachment mechanism for stackable stakes;

FIG. 6 is a second illustration showing an attachment mechanism for stackable stakes;

FIG. 7 is a third illustration showing an attachment mechanism for stackable stakes;

FIG. 8 shows a dual-receiver assembly where more than one stake is stacked onto a single stake;

FIG. 9 shows an example of a use of the dual-receiver assembly;

FIG. 10 shows an enlarged view of a dual-receiver assembly;

FIG. 11 illustrates an attachable dual-receiver assembly; and

FIG. 12 shows a roll dispensing arrangement of the wind screen assembly.

### DETAILED DESCRIPTION OF THE INVENTION

FIG. 1 shows a wind screen formed in a rectangular barrier around some plants.

In FIG. 1, wind screen 100 includes stakes such as 120, 122, 124, etc., secured at regular intervals onto flexible sheet 102 to form a barrier around plants 104. A preferred embodiment of the invention uses stakes approximately 3.5° long. Sheet 102 is also approximately 3.5° in width. Adjacent pairs of stakes create sheet intervals such as 130 and 132. In the preferred embodiment, the sheet intervals are approximately 2′.

Although specific dimensions and characteristics are provided in this specification, other embodiments can use other dimensions and characteristics. For example, the stake height (i.e., length), sheet width, sheet intervals, etc., can be varied as desired. Stakes are actually slightly longer than the sheet width to allow the stakes to be driven into the ground to prevent the barrier from being blown over.

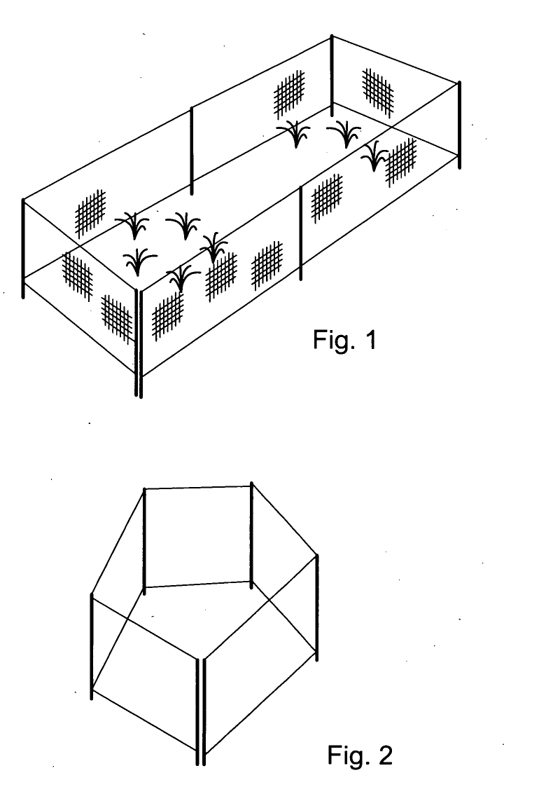

The sheet is flexible to allow for any arbitrary shape of the barrier. For example, FIG. 2 illustrates a circular barrier. In general, any layout, shape or plan can be accommodated by using different sheet, stake and interval dimensions. A linear barrier, such as a fence design, can be used as there is no need to completely enclose the vegetation to be protected.

The sheet can be made of any suitable material such as burlap, canvas or other fabric, plastic, wire mesh, or any other type of flexible or semi-flexible material. A preferred embodiment uses a sheet made of burlap. The sheet material is preferably porous, or permeable, to allow some air to pass through so that the force on the sheet is reduced to prevent the barrier from collapsing in high winds. At the same time, the sheet's permeability to air is small enough so that wind is sufficiently diminished within the barrier so that plants and other vegetation are protected.

FIG. 3 shows an enlarged view of a wind screen using a flexible sheet of material with coupled stakes.

In FIG. 3, stakes such as 150 have a protruding end 152. The protruding end is used to drive the stake into the ground and can be, for example, 4″ to 6″. Alternate embodiments can use stake ends that are sharpened, or are smaller in diameter than the rest of the stake. Any shape of stake can be used. For example, a stake's cross-section can be a triangle, star, circle, square, etc. Stakes need not be entirely straight and some benefit can be obtained, for example, with stakes that are “flattened” (e.g., strips), hollow or have other shapes and designs. For example, a benefit can be that less material is used to make the stakes, or the stakes provide greater structural support.

Stakes can be formed of any suitable material such as plastic, metal, wood, composites, etc. It can be advantageous to make the protruding end of a stake from a material other than the rest of the stake. For example, the protruding end can be metal on an otherwise plastic or wooden stake. Other designs are possible.

In a preferred embodiment, the stakes are secured to the sheet at regular intervals. Securing can be by adhesive, stapling, nailing, etc. Any suitable form of securing can be employed. The stakes can be manufactured integral with the sheet such as where the stakes and sheet are made from the same type of plastic material in, e.g., a compression molding process. Or the stakes can be combined with the sheets in a mechanical affixing, gluing, welding, or other attaching process. Other embodiments can use detachable stakes such as where each stake slips into a pocket that is formed into the sheet.

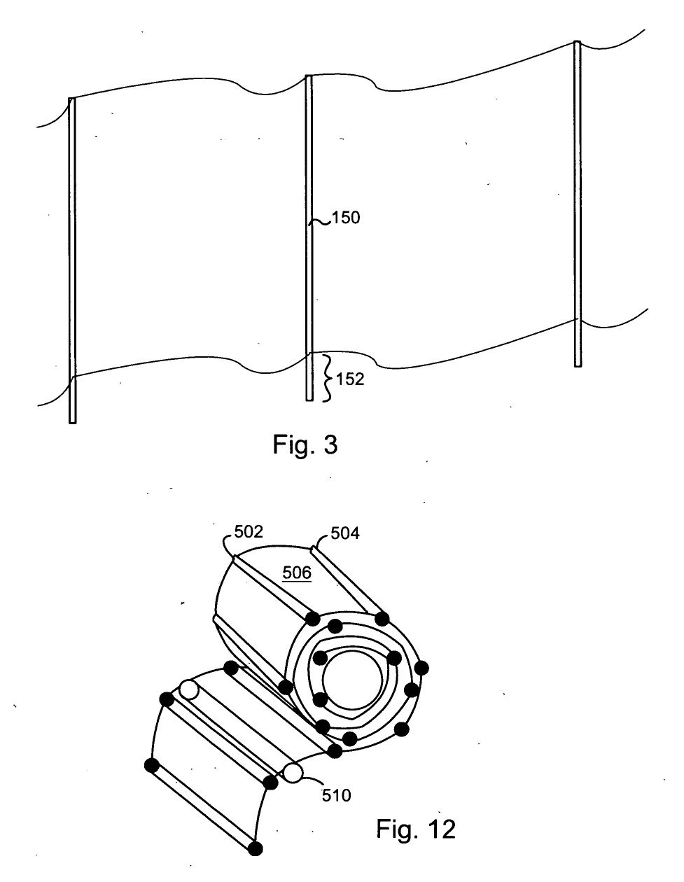

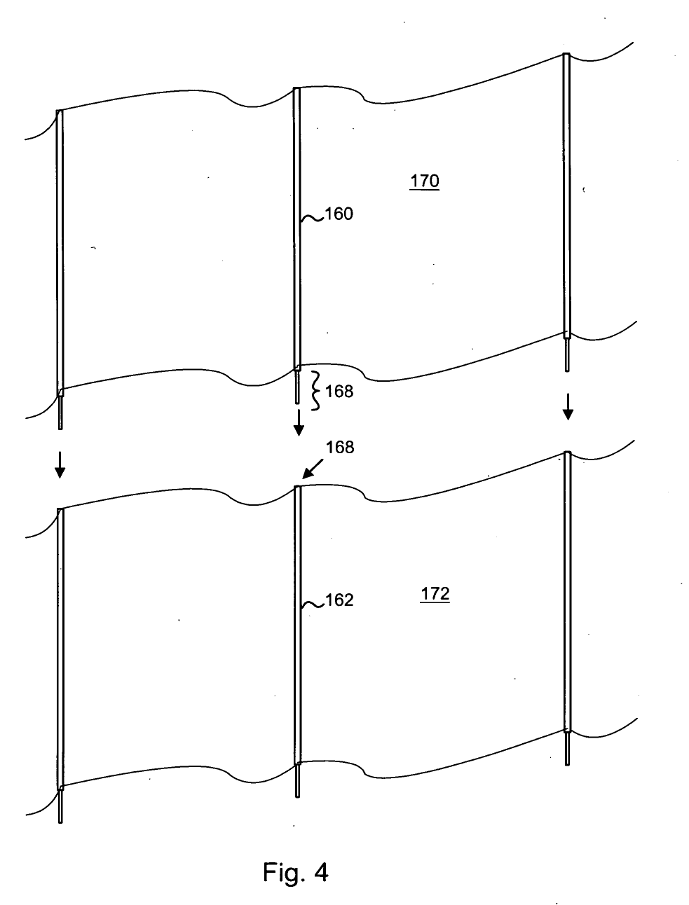

FIG. 4 illustrates stackable stakes 160 and 162 corresponding to two different barrier sheets 170 and 172, respectively. In FIG. 4, stackable stake 160 includes a protruding end 164 that is smaller in diameter than stake body 166. Protruding end 164 can be inserted into receiving mechanism 168 on stake 162. In a preferred embodiment, the receiving mechanism includes a hole into which protruding end 164 fits tightly enough to keep the attached stakes together until separated by pulling by human hands. Each stake is provided with a protruding end such as 164 and a receiving mechanism such as 168. In this way, multi-tiered barriers can be formed.

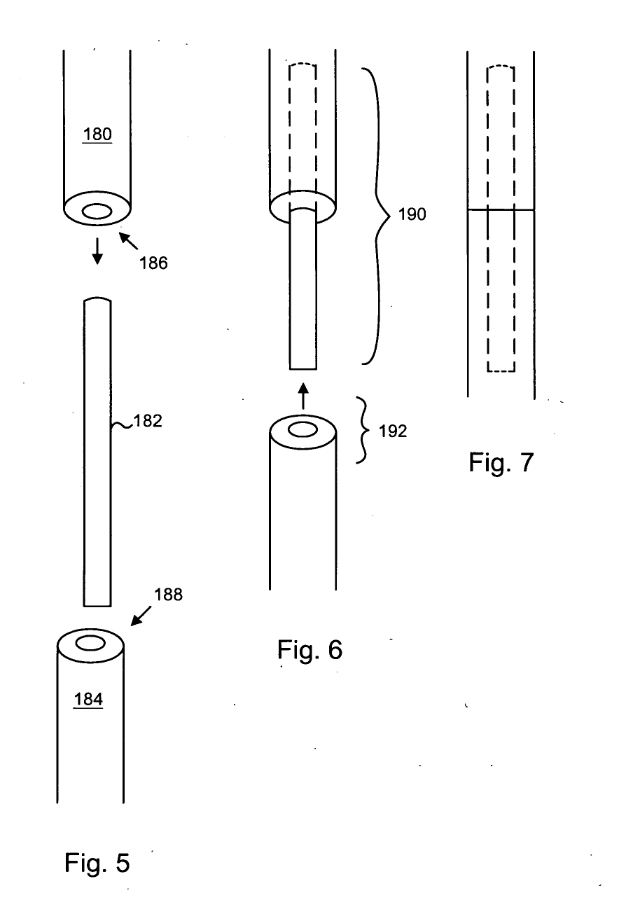

FIGS. 5-7 illustrate attachment mechanisms for stackable stakes. FIG. 5 shows stake 180 and stake 184, each provided with a hole, 186 and 188, respectively, for receiving rod 182. FIG. 6 illustrates the case where the rod is inserted into stake 180. FIG. 7 shows the case where the rod is fitted into both stakes 180 and 184 of FIG. 5. In a preferred embodiment, the bottom part of each stake is formed as shown at 190 of FIG. 6. That is, the bottom part of each stake includes a portion of smaller diameter than the rest of the stake. A rod can be pre-inserted so that the stake is purchased including the rod. Or, the stake can be formed so that the rod is integral with the stake. Other designs are possible. The top parts of the stakes are provided with a hole as shown in FIG. 6. Removable end caps (not shown) can be provided with the stakes to cover the holes at the ends, if desired.

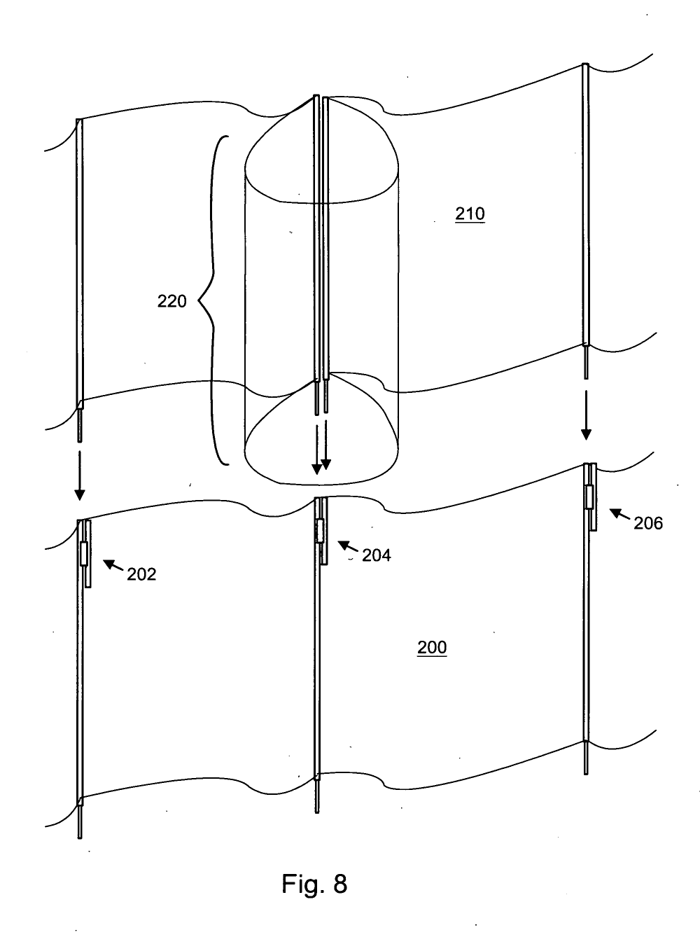

FIG. 8 shows an embodiment of the invention where more than one stake of a top tier can be attached to a bottom tier at substantially the same point. In FIG. 8, bottom barrier 200 includes stakes with dual receivers such as 202, 204 and 206. A dual receiver assembly allows two top stakes to be inserted adjacent to one another, or at substantially the same point. Top barrier 210 is a wind screen as discussed above, for example, in FIGS. 3 and 4, where stakes are at regular intervals. Dual receiver assemblies can be formed as part of the top sections of stakes. Alternatively they can be provided as add-on attachments to an existing stake-and-sheet barrier assembly. For example, a receiver assembly can clip onto an existing top section of a stake.

The use of dual receiver assemblies in bottom barrier 200 allows different approaches to wind screen designs. For example, as shown in FIG. 8, top barrier 210 includes tube 220 formed by aligning two stakes of the barrier so that the sheet is curved into a tube. One of the two stakes is inserted into a top part of a stake of bottom barrier 200 while the other of the two stakes is inserted into the corresponding dual receiver assembly. Assuming the stakes are placed at about 2 foot intervals, the diameter of the tube is about 2 feet.

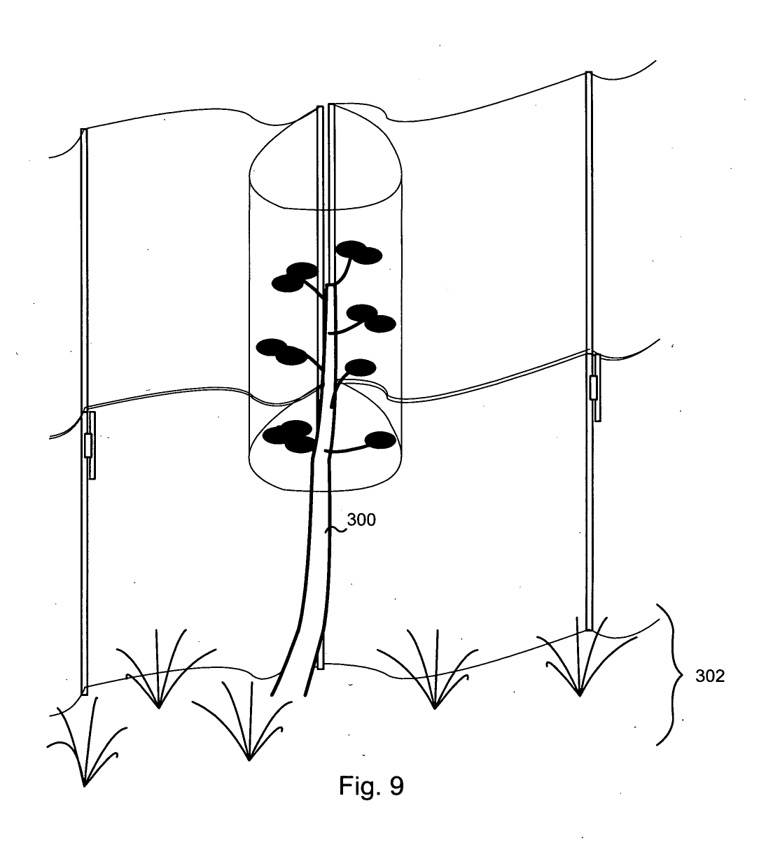

FIG. 9 shows an example of a use of the dual-receiver assembly approach. In FIG. 9, small tree 300 is protected by the tube formed in the top barrier. Note that the bottom portion of the small tree is still protected by the bottom barrier to the same extent as plants at 302. However, the more sensitive leafy, or top, portion of small tree 300 receives a greater degree of protection since it is essentially completely encircled by the barrier material of the top tier. Other variations are possible using dual-receiver assemblies at one or more points at different tiers of a windscreen design. Note that different receiver assemblies can be designed to receive any number of stakes, to hold stakes at different angles or orientations, etc.

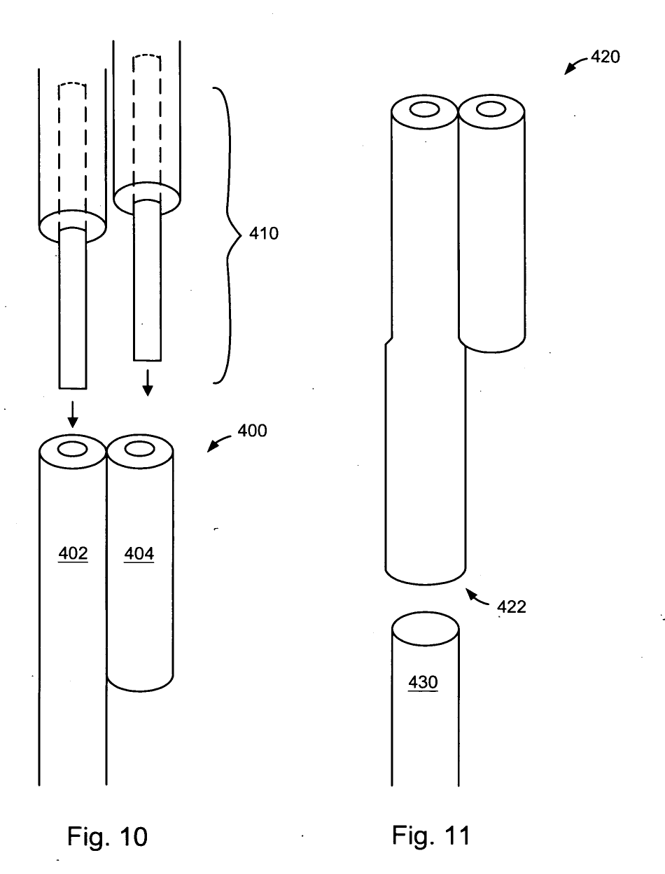

FIG. 10 shows an enlarged view of a dual-receiver assembly such as the 204 of FIG. 8. In FIG. 10, dual-receiver assembly 400 includes portions 402 and 404 for receiving ends of stakes 410. In FIG. 10, portion 402 is the end portion of a stake. Portion 404 is manufactured integrally with portion 402. For example, if the stakes are made of plastic then portion 404 can be formed at the same time as stake 402 as an additional molded part, or by any other suitable means. Portion 404 can be affixed to portion 402 in other manners as by plastic welding, adhesion, etc. Other materials and manufacturing processes can be used, as desired.

FIG. 11 illustrates an attachable dual-receiver assembly, or clip. In FIG. 11, dual-receiver assembly 420 includes end 422 that fits snugly over stake 430. After fitting, stake 430 can be made to support two additional stakes that are placed into openings in the dual-receiver assembly as previously explained. Stake 430 can be a stake as described above, having a hole for receiving a protruding end (or other means for stacking stakes) or stake 430 can be a simple rod, as shown in FIG. 11.

FIG. 12 shows a dispensing arrangement of the wind screen assembly of the present invention. In a preferred embodiment, the sheet can be easily cut, to a desired length. The sheets can be hung as a bolt of cloth, horizontally, for easy dispensing.

In FIG. 12, the wind screen barriers are formed in a roll around rotatable core 500. Stakes such as 502 and 504 are shown spaced at intervals with sheet 506. In FIG. 12, the size and placement of objects is not to scale, for ease of illustration. Guide 510 allows the wind screen assembly to be pulled off the roll to be measured and cut. For example, guide 510 can be used as a surface for cutting the sheet material according to a customer's order, or desire. Other approaches for dispensing and/or cutting the wind screen material from the roll can be used.

Although the invention has been described with reference to specific embodiments, these embodiments are merely illustrative, and not restrictive, of the invention. For example, the receiving mechanism can be of any suitable design. A mechanical device such as a clasp, clamp, tie, etc. can be used to secure two stakes together to extend the overall stake length. Other approaches can use magnetic, adhesive, screw, twist, etc., mechanisms to secure two stakes together.

Thus, the scope of the invention is to be determined solely by the appended claims.

1. An apparatus for blocking wind, the apparatus comprising
a flexible sheet having a length;
a plurality of rods, each having a length, coupled at intervals along the length of the flexible sheet, wherein the rods are disposed with the rods substantially parallel to each other, and wherein the rod lengths are substantially normal to the sheet length.

2. The apparatus of claim 1, wherein the sheet includes a fabric material.

3. The apparatus of claim 1, wherein the sheet includes a plastic material.

4. The apparatus of claim 1, wherein a rod includes metal.

5. The apparatus of claim 1, wherein a rod includes plastic.

6. The apparatus of claim 1, wherein the flexible sheet has a width that is perpendicular to the direction of the flexible sheet's length, wherein the length of a rod is substantially the same size as the width of the flexible sheet.

7. The apparatus of claim 1, wherein the rods are fixedly coupled to the flexible sheet.

8. The apparatus of claim 1, wherein the rods are detachably coupled to the flexible sheet.

9. The apparatus of claim 1, further comprising
an attachment mechanism at the end of a first rod for receiving a second-tier rod to produce a rod combination along the direction of the length of the first rod.

10. The apparatus of claim 9, further comprising
a dual receiving mechanism attached to the attachment mechanism at the end of the first rod for allowing multiple second tier rods to be attached to the first sheet.

11. A method for dispensing a wind screen, wherein the wind screen includes a flexible sheet of material having a length and a width, wherein stakes are attached at intervals to the sheet so that the stakes are perpendicular to the length of the flexible sheet, the method comprising
forming the wind screen into a roll;
unrolling at least a portion of the wind screen; and
separating the at least a portion of the unrolled wind screen from the rolled wind screen.

12. An apparatus for securing a windscreen to a supporting stake, the windscreen including first and second rods attached to a flexible material, the stake suitable for being vertically supported by ground, the apparatus comprising
first and second attachment portions for attaching the first and second rods so that the rods are held adjacent and substantially parallel to each other; and
a third attachment portion coupled to the first and second attachment portions, wherein the third attachment portion allows mounting of the apparatus to the stake.

13. The apparatus of claim 12, wherein the first and second rods are held by the apparatus in a position above, and substantially parallel to, the stake.

14. The apparatus of claim 12, wherein the first and second rods are held by the apparatus substantially in-line with a length of the stake.

15. The apparatus of claim 12, wherein the apparatus is integral with the stake.

16. The apparatus of claim 12, wherein the apparatus is removably coupled to the stake.

17. The apparatus of claim 12, wherein an attachment portion includes a hole for receiving an end of a rod.
